(19) United States
(12) Patent Application Publication
(10) Pub. No.: US 2010/0017479 A1
(43) Pub. Date: Jan. 21, 2010

(54) METHOD AND SYSTEM FOR PROVIDING PROXY FUNCTIONALITY IN A MESSAGE CLIENT

(75) Inventors: Barbara Febonio, Rome (IT); Mario Noioso, Rome (IT); Sandro Piccinini, Rome (IT); Marco Secchi, Rome (IT)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/174,576

(22) Filed: Jul. 16, 2008

(51) Int. Cl. G06F 15/16

(52) U.S. Cl. 709/206

(57) ABSTRACT

A method and system for communicating electronic messages among clients in a network is provided. One implementation involves marking an electronic message to indicate that the message is to be routed to recipient clients identified by a user group definitions, sending the marked message from a sender client to a proxy client, parsing an incoming message at the proxy client to detect an indication that the message is to be routed to recipient clients in a user group, and routing the message from the proxy client to one or more recipients in the user group based on the user group definition.

### BACKGROUND OF THE INVENTION

1. Field of the Invention

The present invention relates generally to electronic message communication, and in particular to electronic message communication among clients in a communication network.

2. Background Information

With the proliferation of interconnected networks, there has been an increase in the number of collaboration systems. Examples of typical collaboration systems include chat or e-mail clients which utilize aliases or groups to exchange messages with a group of users identified by a specific group name.

The grouping of a user can be defined centrally in servers accessible by all users, or local to the client device for a user. However, when a user receives e.g., an e-mail sent from a specific group name that is locally defined in a sender client, the user is not able to leverage the “Reply All” capability of the client. In the same way, if a user desires instantiate a multipart chat with a group defined in another client, the user is not able to do so without obtaining the group definition in advance.

### SUMMARY OF THE INVENTION

The invention provides a method and system for communicating electronic messages among clients in a network. One embodiment involves marking an electronic message to indicate that the message is to be routed to recipient clients identified by a user group definition; sending the marked message from a sender client to a proxy client; parsing an incoming message at the proxy client to detect an indication that the message is to be routed to recipient clients in a user group; and routing the message from the proxy client to one or more recipients in the user group based on the user group definition.

The user group may comprise a local user group, and the sender client and the proxy client are in the local user group, wherein routing the message includes routing the message to multiple recipients in the user group. Said electronic message may comprise a reply to a message initially received from the proxy client by the sender client, and said message initially received from the proxy client was addressed to the user group.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a functional block diagram of a network system implementing an embodiment of the invention.

FIG. 2 shows a flowchart of a process for client proxy function, according to an embodiment of the invention.

FIG. 3 shows a functional block diagram of an e-mail agent for marking a message such that it is routed to a user group by a proxy client, according to an embodiment of the invention.

FIG. 4 shows a functional block diagram of a routing agent of a proxy client, for routing incoming marked messages to a user group, according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The invention provides a method and system for providing proxy functionality in an electronic message client, such as in collaboration networks. One embodiment involves a proxy function implementing a server capability for electronic clients, wherein each such client acts as a “server” able to automatically re-route (forward) messages incoming from another client.

The forwarding feature is implemented by a sender that wants to leverage another client defined group or alias (and not a trigger on reply message or an automatic forwarding of all messages to a specified group). A routing (forwarding) agent (RA) updates each involved client in order to have a fully up-to-date copy of the message (with all receivers named). The routing capability can be applied in various electronic systems such as e.g., collaboration systems.

For example, when a user 1 receives a message from a user 2 (wherein the message is sent to a group that both users belong to), user 1 can reply to user 2 by marking that the specific reply must be routed to said group. User 2 then reroutes the message to the group. Examples of marking may be appending local user group identification information in a marked message and setting a field in the message to indicate that the message is to be routed to one or more users (recipients) in the local user group.

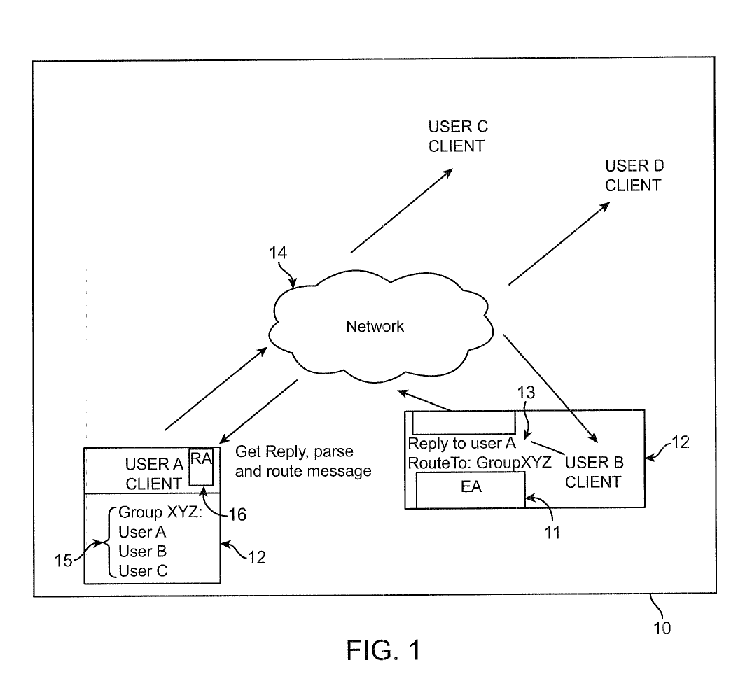

FIG. 1 shows a functional block diagram of a system 10 implementing an embodiment of the invention. The system 10 includes multiple clients 12 (e.g., e-mail clients executing on personal computers), capable of communicating via a network 14 (e.g., the Internet). For example, the client 12 sends/receives message via the network 14 using addresses such as IP addresses on the Internet. Each client 12 is utilized by a user (e.g., users A, B, C, D) for sending/receiving electronic messages (hereinafter messages). In this example, users A and B each belong to a user group GROUPXY.

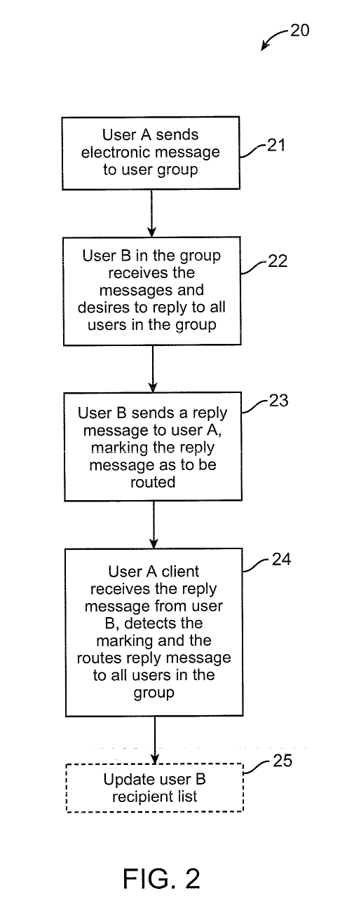

FIG. 2 shows a flowchart of a proxy process 20 implemented by the system in, according to an embodiment of the invention, as follows:
Block 21: User A, part of local user group GROUPXYZ, sends an electronic message to group GROUPXYZ.
Block 22: User B, part of the group GROUPXYZ, receives the message and desires to send a reply message that is received by all users in the group GROUPXYZ.
Block 23: User B (i.e., sender client) sends a reply message to user A marking the reply message as to be routed in one example, (e.g., an email agent (EA) 11 in user B marks the reply message 13 as “RouteTo: GROUPXYZ” to be routed or re-routed by user A client to user recipients in group GROUPXYZ).
Block 24: User A (i.e., proxy client) receives the reply message from user B and, and routing agent (RA) 16 of user A client parses the reply message, and based on said marking recognizing that the message must be routed, and so the routing agent routes (forwards) the message to all users in the group GROUPXYZ (e.g. user C). In one embodiment, the message is routed only to other users in the group (excluding users A and B).
Block 25: Optionally the reply message in the user B client is updated with a complete list of recipient users. The user B client has in his inbox the message sent to user A and GroupXYZ (he has not locally defined). When the user A sends the message to the group, and specifically to the list of people belonging to the group, a possible option is that user A sends an acknowledgment to user B with the list of users, and the sent message is accordingly changed.

The transmission, reception and handling of the electronic messages for the users are handled by the client devices 12 for the users. The invention is applicable to all collaboration systems including chat or e-mail. A first user (e.g., user B above) can decide that a second user (e.g., user A above) acts as a proxy for the first user messages, leveraging the local group or alias definition. The system may iterate the proxy feature as needed. The sender client (e.g., user B) is not required to have knowledge of (or access to) the group definition 15 (FIG. 1). However, the sender client knows which proxy client (e.g., user A) owns the group definition 15. The client sending the first mail has the group defined, which the proxy client may use. The first user replies so he also knows that it is the sender (since he wants to use reply all) that has the information. The system can also be iterated since all replies will be related to the same mail thread (so identified by a unique identifier), and each client can check on an email about its original sender. Based on such knowledge, the sender message is marked (e.g., by email agent 11) in a special way so that when the sender (e.g., user B) sends the message to the group owner (e.g., user A), the owner client (e.g., routing agent 16) acting as a proxy for the sender, is able to process the message and determine that the message must be delivered to the entire group. In a preferred embodiment, the proxy client (e.g., user A) that performs rerouting, has the group definition and is the client that initially transmitted a message to a sender client (e.g., user B). As such, in the preferred embodiment a client that initially sends the message knows group definition. Further, if a user X knows that a user Y has a local a group definition, the user X may initiate a message exchange indicating user Y as proxy. For example, a user who is a second line manager has a local definition of people belonging to his staff, and he calls it “MyStaff”. A first line manager does not have such a definition but knows that the second line manager owns it. As such, the first line manager can send a message to “MyStaff” instrumenting the client to use the second line address as a proxy.

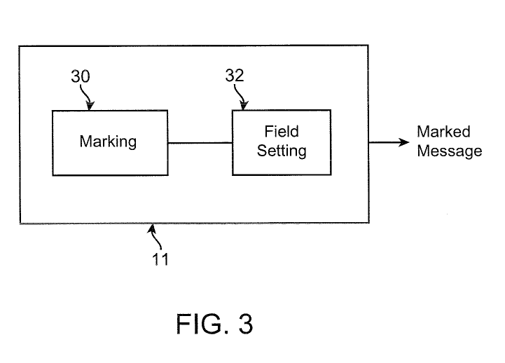

FIG. 3 shows an example implementation of the e-mail agent 11, involving a client plug-in (e.g., software agent) installed on the actual client 12 (e.g., client for user B). The plug-in 11 includes a marking module 30 for marking messages for routing. The plug-in 11 provides the client with a function 32 to set message field information allowing the marked message to be routed (e.g., an additional field for example respect to “To:”, “CC:” that may be called “RouteTo:”).

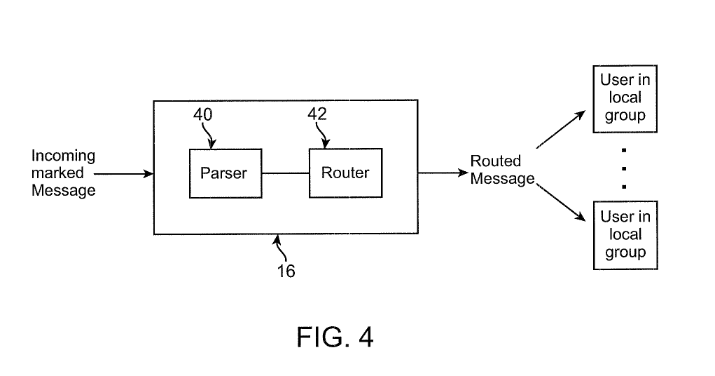

FIG. 4 shows an example implementation of the routing agent 16, involving a client plug-in installed in the client 12 (e.g., client for user A). The plug-in 16 includes a parser 40 configured for parsing incoming messages to detect said routing marking, and a router 42 configured for automatically (or according to a configurable setting prompting the user), forwarding each incoming marked message to the name and/or group specified in the additional field. The proxy client has the user group definition information and client addresses to which the message is to be routed.

Though in the above examples a sender client marks a reply message for routing by a proxy client, the invention is not limited to such an implementation. For example, the sender client may generate a new message which is not a reply to any other messages, wherein the sender device marks the newly generated message to be routed and sends the message to a proxy client to route to users in a local user group.

The same techniques are also useful in chatting systems allowing each user to leverage group definitions in another client to deliver chat messages to multiple users in the group.

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof; however, other versions are possible. Therefore, the spirit and scope of the appended claims should not be limited to the description of the preferred versions contained herein.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method of communicating electronic messages among clients in a network, comprising:
marking an electronic message to indicate that the message is to be routed to recipient clients identified by a user group definition;
sending the marked message from a sender client to a proxy client;
parsing an incoming message at the proxy client to detect an indication that the message is to be routed to recipient clients in a user group; and
routing the message from the proxy client to one or more recipients in the user group based on the user group definition.

2. The method of claim 1 wherein the user group comprises a local user group, and the sender client and the proxy client are in the local user group.

3. The method of claim 2 wherein routing the message includes routing the message to multiple recipients in the user group.

4. The method of claim 1 wherein the electronic message comprises an electronic mail message.

5. The method of claim 1 wherein the electronic message comprises a chat message.

6. The method of claim 1 wherein said electronic message comprises a reply to a message initially received from the proxy client by the sender client.

7. The method of claim 6 wherein said message initially received from the proxy client was addressed to the user group.

8. The method of claim 1 wherein the network includes the Internet and the clients include electronic messaging clients.

9. A system for communicating electronic messages among clients in a network, comprising:
a marking module configured for marking an electronic message to indicate that the message is to be routed to recipient clients identified by a user group definition, and sending the marked message from a sender client to a proxy client; and
a routing module configured for parsing an incoming message at the proxy client to detect an indication that the message is to be routed to recipient clients in a user group, and routing the message to one or more recipients in the user group based on the user group definition.

10. The system of claim 9 wherein the user group comprises a local user group, and the sender client and the proxy client are in the local user group.

11. The system of claim 10 wherein the marking module is further configured for routing the message to multiple recipients in the user group.

12. The system of claim 9 wherein the electronic message comprises an electronic mail message.

13. The system of claim 9 wherein the electronic message comprises a chat message.

14. The system of claim 9 wherein said electronic message comprises a reply to a message initially received from the proxy client by the sender client.

15. The system of claim 14 wherein said message initially received from the proxy client was addressed to the user group.

16. The system of claim 9 wherein the network includes the Internet and the clients include electronic messaging clients.

17. A system for communicating electronic messages, comprising:
a sender client including a marking module configured for marking an electronic message to indicate that the message is to be routed to recipient clients identified by a user group definition, and sending the marked message from a sender client to a proxy client; and
a proxy client including a routing module configured for parsing an incoming message at the proxy client to detect an indication that the message is to be routed to recipient clients in a user group, and routing the message to one or more recipients in the user group based on the user group definition.

18. The system of claim 17 wherein the user group comprises a local user group, and the sender client and the proxy client are in the local user group.

19. The system of claim 17 wherein said electronic message comprises a reply to a message initially received from the proxy client by the sender client, and said message initially received from the proxy client was addressed to the user group.

20. The system of claim 17 further including a communication link for electronic message communication between the clients.
